(19) United States
(12) Patent Application Publication
(10) Pub. No.: US 2005/0259843 A1
(43) Pub. Date: Nov. 24, 2005

(54) Dome-shaped diaphragm and speaker

(75) Inventors: Minoru Horigome, Yamagata (JP); Hiroshi Sato, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/130,249

(22) Filed: May 17, 2005

(30) Foreign Application Priority Data
May 18, 2004 (JP) P2004-148384

(51) Int. Cl. H04R 1/00; H04R 9/06

(52) U.S. Cl. 381/430; 381/423

(57) ABSTRACT

A dome-shaped diaphragm includes a dome part which is formed in a dome-like shape and is convex forward in an oscillating direction, a neck part which is provided in continuation to an outer periphery of the dome part, and an edge including a roll part which is formed in a curved shape and is convex forward in the oscillating direction, and continued to the neck part at an inner peripheral edge thereof, wherein the neck part is provided with a curved portion which is convex backward in the oscillating direction, and an outer periphery of the curved portion is smoothly continued to an inner periphery of the roll part.

The present disclosure relates to the subject matter contained in Japanese Patent Application No. 2004-148384 filed on May 18, 2004, which is incorporated herein by reference in its entirety.

### BACKGROUND OF THE INVENTION

1. Field of the Invention

The present invention relates to a dome-shaped diaphragm including a dome part which is convex forward in an oscillating direction and has a neck part at an outer peripheral part thereof, and an edge part having a roll part which is convex forward in the oscillating direction and is provided in continuation to the neck part, and more particularly, to an improvement for enhancing rigidity of the edge part by increasing a rising height of the roll part without sacrificing acoustic characteristics.

2. Description of the Related Art

FIG. 1 shows a structure of a dome-shaped speaker unit in which a dome-shaped diaphragm is employed.

This speaker unit 1 includes a magnetic circuit 3, a speaker frame 5 having this magnetic circuit 3 attached to a rear part thereof, a dome-shaped diaphragm 7 having an edge 9 continuously provided at an outer peripheral part thereof, and a voice coil 12 which is wound around a voice coil bobbin 11 in a cylindrical shape.

The magnetic circuit 3 includes a yoke 15 having a center pole 15b in a cylindrical shape which is projected from a center part of a disc-shaped plate 15a, a magnet 16 in a ring-like shape which is loosely fitted to an outer periphery of the center pole 15b, and a top plate 17 in a ring-like shape which is loosely fitted to a distal end area of the center pole 15b in such a manner that the magnet 16 is interposed between the top plate 17 and the plate 15a.

A magnetic gap 19 for disposing the voice coil 12 is formed between an inner periphery of the top plate 17 and the center pole 15b.

The dome-shaped diaphragm 7 has a dome part 7a in a dome-like shape which is convex forward in an oscillating direction, a neck part 7b which is provided in continuation to an outer peripheral part of this dome part 7a for permitting the voice coil bobbin 11 to be fixed thereto, and the edge 9 having a roll part 9a in a curved shape which is convex forward in the oscillating direction. An inner peripheral edge of the roll part 9a is connected to the neck part 7b.

A flange part 9b is extended from an outer peripheral part of the edge 9. This flange part 9b is fixed to an edge supporting part 5a in the front of the speaker frame 5, in a state held between the edge supporting part 5a and a ring-shaped gasket 21 which is attached to the edge supporting part 5a.

In the related-art dome-shaped diaphragm 7, the neck part 7b is generally in a shape of a straight tube having a short length, so that a distal end of the voice coil bobbin 11 can be engaged with the neck part 7b. A connecting portion between this neck part 7b and the inner peripheral edge of the roll part 9a is formed as a bent part, as shown in FIG. 1, which is bent at an acute angle θ (Refer to JP-A-2003-32790, for example).

### SUMMARY OF THE INVENTION

By the way, as a home theater system and so on has become popular, max power input of the speaker unit has been required to be enhanced, in order to realize reproduction of stentorian sounds with high grade.

For the purpose of enhancing the max power input, it is indispensable to enhance rigidity of the edge that permits oscillation of the diaphragm.

In the above-described dome-shaped diaphragm 7, it would be effective, for enhancing the rigidity of the edge 9, to erect an inclination of the inner peripheral part of the edge 9 toward the dome part 7a thereby to make an inclination angle α of the inner peripheral part of the edge 9 larger.

However, in the related-art dome-shaped diaphragm 7, when the inclination angle α of the inner peripheral edge of the edge 9 is made larger, an apex 9c of the roll part 9a is projected forward in the oscillating direction of the diaphragm, as shown by a phantom line in FIG. 1. Accordingly, a projecting height of the apex 9c of the roll part 9a is increased by a height h1, so that the apex 9c of the roll part 9a may be positioned at substantially the same level as an apex 7c of the dome part 7a.

In such a structure of the diaphragm in which the height of the roll part 9a is increased with respect to the dome part 7a, as described above, there arises a problem that a sound emitted from the dome part 7a interferes with the roll part 9a, and acoustic characteristics are liable to be disturbed.

Moreover, in the related-art dome-shaped diaphragm 7, because the connecting portion between the neck part 7b at the outer peripheral part of the dome part 7a and the inner peripheral part of the roll part 9a is formed as the bent part at an acute angle, performing stabilized molding is difficult, and at the same time, concentration of stress is likely to occur when the dome part 7a oscillates. Moreover, in case where the inclination of the inner peripheral part of the edge 9 is erected for the purpose of enhancing the rigidity of the edge 9, the connecting portion between the neck part 7b and the roll part 9a is formed as a more acutely bent structure. Consequently, there is such anxiety that yield of the products may be lowered because pin holes may be generated due to deterioration of molding performance, or durability may be decreased because rupture becomes likely to occur due to concentration of stress.

As the problems to be solved by this invention, there is a problem, which has happened in the above-described related art, that in case where the inclination of the inner peripheral part of the edge is erected for the purpose of enhancing the rigidity of the edge, the apex of the roll part of the edge is positioned at substantially the same level as the apex of the dome part, and sounds emitted from the dome part may interfere with the roll part, resulting in disturbance of the acoustic characteristics. There is another problem that the connecting portion between the neck part and the roll part is formed as a more acutely bent structure, and defects such as pin holes and ruptures may become likely to occur.

According to an aspect of the invention, there is provided a dome-shaped diaphragm including: a dome part which is formed in a dome-like shape and is convex forward in an oscillating direction; a neck part connected to an outer periphery of the dome part for fixing a voice coil bobbin thereto; and an edge including a roll part which is formed in a curved shape, convex forward in the oscillating direction, and continued to the neck part at an inner peripheral edge thereof, and a flange part which is provided at an outer peripheral edge of the roll part to be fixed to a speaker frame; wherein the neck part is provided with a curved portion which is convex backward in the oscillating direction, and an outer periphery of the curved portion is continued to an inner periphery of the roll part.

### BRIEF DESCRIPTION OF THE DRAWINGS

FIG. 1 is a vertical sectional view of a speaker unit in which a dome-shaped diaphragm in the related art is employed, showing the diaphragm of an acoustic transducer; and

FIG. 2 is a vertical sectional view of an embodiment of a speaker unit in which a dome-shaped diaphragm according to of the invention is employed.

### DETAILED DESCRIPTION OF THE PREFERRED EMBODIMENTS

Now, a preferred embodiment of a dome-shaped diaphragm according to the invention will be described in detail, referring to the drawing.

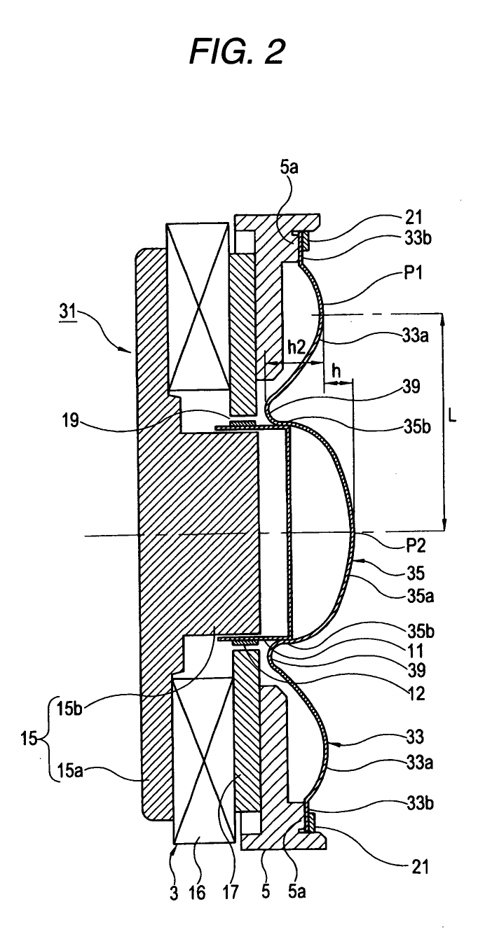

FIG. 2 is a vertical sectional view of an embodiment of a dome-shaped speaker unit in which the dome-shaped diaphragm according to the invention is employed.

This speaker unit 31 includes a magnetic circuit 3, a speaker frame 5 having the magnetic circuit 3 attached to a rear part thereof, a dome-shaped diaphragm 35 having an edge 33 continuously provided at an outer periphery thereof, and a voice coil 12 which is wound around a voice coil bobbin 11 in a cylindrical shape.

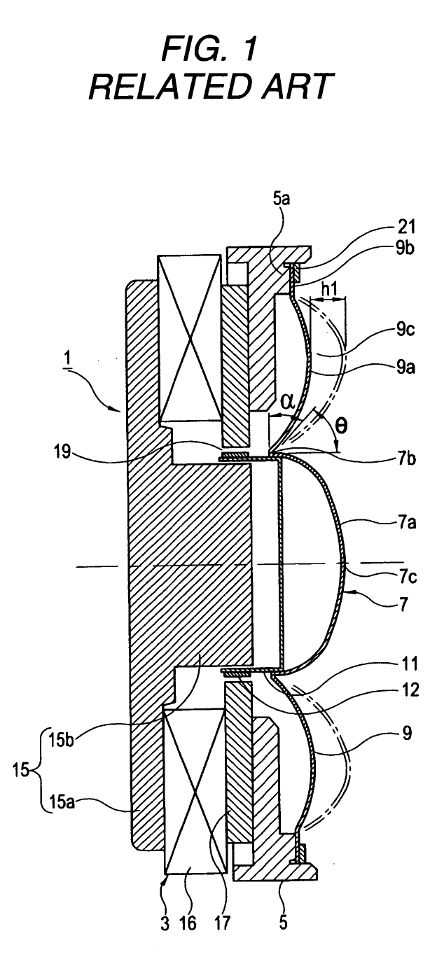

The magnetic circuit 3, speaker frame 5, voice coil bobbin 11, voice coil 12 and so on, among constituent components of the speaker unit 31 are the same as those components of the related art illustrated in FIG. 1. Therefore, they are herein denoted with the same reference numerals, and their detailed explanation will be omitted.

The dome-shaped diaphragm 35 has a dome part 35a in a dome-like shape which is convex forward in an oscillating direction of the diaphragm, a neck part 35b which is provided in continuation to an outer periphery of this dome part 35a for permitting the voice coil bobbin 11 to be fixed thereto, and an edge 33 having a roll part 33a in a curved shape which is convex forward in the oscillating direction. An inner peripheral edge of the roll part 33a is continued to the neck part 35b.

A flange part 33b is extended from an outer peripheral edge of the edge 33. This flange part 33b is fixed to an edge supporting part 5a in the front of the speaker frame 5, in a state held between the edge supporting part 5a and a ring-shaped gasket 21 which is attached to the edge supporting part 5a.

The neck part 35b is in a shape of a straight tube having a short length so that a distal end of the voice coil bobbin 11 can be engaged therewith.

In case of the dome-shaped diaphragm 35 in this embodiment, a curved portion 39 which is convex backward in the oscillating direction (that is, toward the magnetic circuit 3) is provided so as to extend from the neck part 35b, and an outer periphery of this curved portion 39 is smoothly (so as not to be formed as an acutely bent structure) continued to the inner periphery of the roll part 33a.

The curved portion 39 continuously provided from the neck part 35b has a curved face which has a smaller radius of curvature than a curved face of the roll part 33a.

Moreover, curvature of the roll part 33a is so determined that an apex P1 of the roll part 33a can be lower in height than an apex P2 of the dome part. Accordingly, there is created a difference h in height between the two apexes P1 and P2.

The dome-shaped diaphragm 35 according to the embodiment includes the dome part 35a which is formed in a dome-like shape convex forward in the oscillating direction, the neck part 35b which is provided in continuation to the outer periphery of the dome part 35a for permitting the voice coil bobbin 11 to be fixed thereto, and the edge 33 including the roll part 33a which is formed in a curved shape, convex forward in the oscillating direction, and continued to the neck part 35b at the inner peripheral edge thereof, and the flange part 33b which is provided at the outer peripheral edge of the roll part 33a and fixed to the speaker frame, wherein the neck part 35b is provided with the curved portion 39 which is convex backward in the oscillating direction, and the outer periphery of the curved portion 39 is continued to the inner periphery of the roll part 33a.

Accordingly, the curved portion 39 which is provided continuously from the neck part 35b at the outer periphery of the dome part 35a has a curved shape which is convex backward in the oscillating direction, contrarily to the roll part 33a of the edge 33, and functions to retract its joint position with the inner peripheral edge of the roll part 33a of the edge 33 backward in the oscillating direction.

For this reason, a rising height of the roll part 33a (a height difference h2 from a bottom of the curved portion 39 to the apex P1 of the roll part 33a) can be sufficiently secured without changing a position of the apex P1 of the roll part 33a of the edge 33, and in this manner, enhancement of the rigidity of the edge 33 due to an increase in the rising height of the roll part 33a can be attained.

In other words, the rising height h2 of the roll part 33a can be increased without changing a vertical position of the apex P1 of the roll part 33a of the edge 33, and the height difference h between the two apexes P1 and P2 of the roll part 33a and the dome part 35a can be thus maintained. Therefore, it is possible to prevent the apex of the roll part 33a from protruding forward in the oscillating direction, which would cause a sound emitted from the dome part 35a to interfere with the roll part 33a. In this manner, disturbance of acoustic characteristics due to interference of the sound with the roll part 33a can be eliminated, and hence, the rigidity of the edge part 33 can be increased, without sacrificing the acoustic characteristics.

Further, the position of the apex P1 of the roll part 33a can be shifted radially outwardly because of presence of the curved portion 39, and a distance L in a horizontal direction between the two apexes P1 and P2 can be increased. This also contributes in preventing the interference of sounds with the roll part 33a.

In addition, the curved portion 39 which is provided continuously from the neck part 35b at the outer periphery of the dome part 35a is smoothly continued to the inner peripheral edge of the roll part 33a of the edge 33, and hence, the connecting portion between the neck part 35b and the roll part 33a is not formed as a bent structure at an acute angle, which would be a cause for a pin hole or rupture.

Therefore, deterioration of the molding performance due to the bent structure at an acute angle and occurrence of concentration of stress during the oscillating action can be prevented. As the results, occurrence of a pin hole due to deterioration of the molding performance and rupture due to concentration of stress can be prevented, and hence, increase in yield of the product and max power input can be achieved.

It is also possible to make the curved portion 39 compact, by setting the radius of curvature of the curved portion 39 smaller than the radius of curvature of the roll part 33a, as shown in the above described embodiment.

Still further, it is possible to reliably prevent the sound emitted from the dome part 35a from interfering with the roll part 33a, by restricting the curvature of the roll part 33a so that the apex P1 of the roll part 33a can be lower in height than the apex P2 of the dome part 35a.

1. A dome-shaped diaphragm comprising:
a dome part which is formed in a dome-like shape and is convex forward in an oscillating direction;
a neck part connected to an outer periphery of the dome part for fixing a voice coil bobbin thereto; and
an edge including a roll part which is formed in a curved shape, convex forward in the oscillating direction, and continued to the neck part at an inner peripheral edge thereof, and a flange part which is provided at an outer peripheral edge of the roll part to be fixed to a speaker frame;
wherein the neck part is provided with a curved portion which is convex backward in the oscillating direction, and an outer periphery of the curved portion is continued to an inner periphery of the roll part.

2. The dome-shaped diaphragm according to claim 1, wherein the curved portion of the neck part has a curved face a radius of curvature of which is smaller than that of a curved face of the roll part.

3. The dome-shaped diaphragm according to claim 1, wherein a curvature of the roll part is set so that an apex of the roll part is lower in height than an apex of the dome part.

4. The dome-shaped diaphragm according to claim 1, wherein the curved portion is smoothly connected to the inner periphery of the roll part without forming a corner.

5. A speaker comprising:
a magnetic circuit;
a speaker frame;
a voice coil bobbin having a voice coil wound around the voice coil bobbin, the voice coil bobbin being oscillated by the magnetic circuit; and
a diaphragm attached to the voice coil bobbin and the speaker frame, the diaphragm including:
a dome part which is formed in a dome-like shape and is convex forward in an oscillating direction;
a neck part connected to an outer periphery of the dome part for fixing the voice coil bobbin thereto; and
an edge including a roll part which is formed in a curved shape, convex forward in the oscillating direction, and continued to the neck part at an inner peripheral edge thereof, and a flange part which is provided at an outer peripheral edge of the roll part to be fixed to the speaker frame;
wherein the neck part is provided with a curved portion which is convex backward in the oscillating direction, and an outer periphery of the curved portion is continued to an inner periphery of the roll part.
